(19) United States
(12) Patent Application Publication
(10) Pub. No.: US 2026/0072409 A1
(43) Pub. Date: Mar. 12, 2026

(54) WATCHCASE WITH BAYONET CONNECTOR AND BOLT

(71) Applicant: ETA SA Manufacture Horlogère Suisse, Grenchen (CH)

(72) Inventors: Roger Willemin, Grenchen (CH); Martial Bringolf, Le Landeron (CH)

(73) Assignee: ETA SA Manufacture Horlogère Suisse, Grenchen (CH)

(21) Appl. No.: 19/286,813

(22) Filed: Jul. 31, 2025

(30) Foreign Application Priority Data
Sep. 9, 2024 (EP) 24199217.1

(51) Int. Cl. G04B 37/00

(52) U.S. Cl. CPC G04B 37/0033

(57) ABSTRACT

A watchcase (1) including a middle (3) suitable for holding a movement (8) and a cell (9) slotted in a compartment of the movement (8), a back (2) assembled with a bayonet connector in the middle (3) and a bolt (6) fitted on the bayonet connector to lock any relative rotation between the back (2) and the middle (3).

### CROSS REFERENCE TO RELATED APPLICATIONS

This application claims priority to European Patent Application No. 24199217.1, filed on Sep. 9, 2024, the entire contents of which are incorporated herein by reference.

### TECHNICAL FIELD OF THE INVENTION

The invention relates to a watchcase suitable for an electronic watch. More specifically, it relates to a watchcase comprising a middle and a back assembled with a bayonet connector fitted with a bolt to secure access to the cell.

### TECHNOLOGICAL BACKGROUND

Portable electronic items can be powered by one or more detachable energy sources, such as batteries, accumulators or cells.

For example, electronic or electromechanical watches are powered, at least in part where electromechanical watches are concerned, by a detachable source of electrical energy, for example a button cell, embedded in a compartment in the watchcase. A detachable cover is provided to enclose the cell inside the compartment, guaranteeing that the compartment is at least water-resistant. The cell is usually embedded in a battery compartment closed by a cover on the back of the watchcase.

To ensure easy replacement of the cell, the cover and the case usually feature quick-release rotational coupling/uncoupling means that enable ready access to the cell and quick fastening of the compartment once the cell has been replaced. Examples of these quick-release coupling/uncoupling means are quarter-turn-type assembly systems or bayonet-type assembly systems.

In addition, the cover can have an impression on its outer surface configured to receive the end of a tool so that the cover can be rotated. To make cell replacement even easier, this impression often has a relatively simple, common shape, such as a slot, so that various accessories readily available to the wearer can be used to open the compartment with no need for a specific tool or to take the watch to a horologist to have the cell replaced.

However, these various interesting and advantageous technical solutions for replacing the cell can also have drawbacks in some situations, particularly if they are handled by children, especially young children. Indeed, these young children might manage to remove the cell cover and access the cell compartment, resulting in a risk of swallowing the cell, with all the serious consequences that could entail.

Accordingly, there is a need to secure watchcases to prevent unauthorised access to the cell compartment, particularly by young children, while keeping the benefits of quick and easy cover removal.

### SUMMARY OF THE INVENTION

The present invention provides a watchcase design that makes it possible to secure the access to an accumulator or to a cell.

According to the invention, the watchcase results from the assembly of the back and the middle by means of a bayonet connector. The entire assembly is secured by a bolt that keeps the back from rotating relative to the middle.

More specifically, the invention relates to a watchcase comprising a middle suitable for holding a movement and a cell slotted in a compartment of the movement, a back assembled with a bayonet connector in the middle and a bolt fitted on the bayonet connector to lock any relative rotation between the back and the middle.

This arrangement enables the electrical energy source to be placed inside the watchcase with bolting means that prevent access to the energy source without specific tools. This makes it possible to assemble and disassemble a watchcase, while providing secure access to the accumulator or cell. The back as such forms the cell cover. Unlike a cell compartment with a cover, this arrangement makes it easy to position a bolt.

### BRIEF DESCRIPTION OF THE FIGURES

FIG. 1A shows an exploded view of the watchcase according to the invention. FIG. 1B shows a three-dimensional view of the back.

FIG. 2 shows a three-dimensional view of the watchcase according to the invention.

FIG. 3 shows a partial vertical cross-sectional view of the bayonet connector.

FIG. 4 shows a three-dimensional view of the bolt according to one variant.

FIG. 5 shows a horizontal cross-sectional view of the watchcase with this variant bolt.

FIG. 6 shows a partial vertical cross-sectional view of this variant bolt within the watchcase with the positioning of the tool for removing the bolt.

FIG. 7 shows a horizontal cross-sectional view of the watchcase fitted with the bolt according to another variant, with an enlargement of the bolt on the bayonet connection.

### DETAILED DESCRIPTION OF THE INVENTION

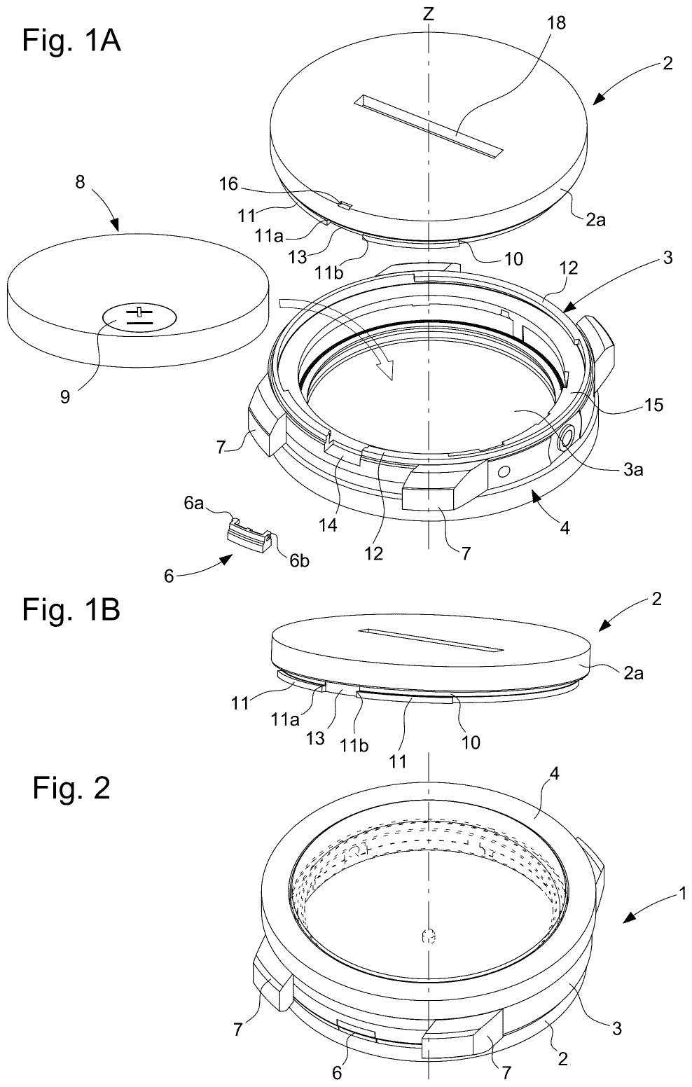

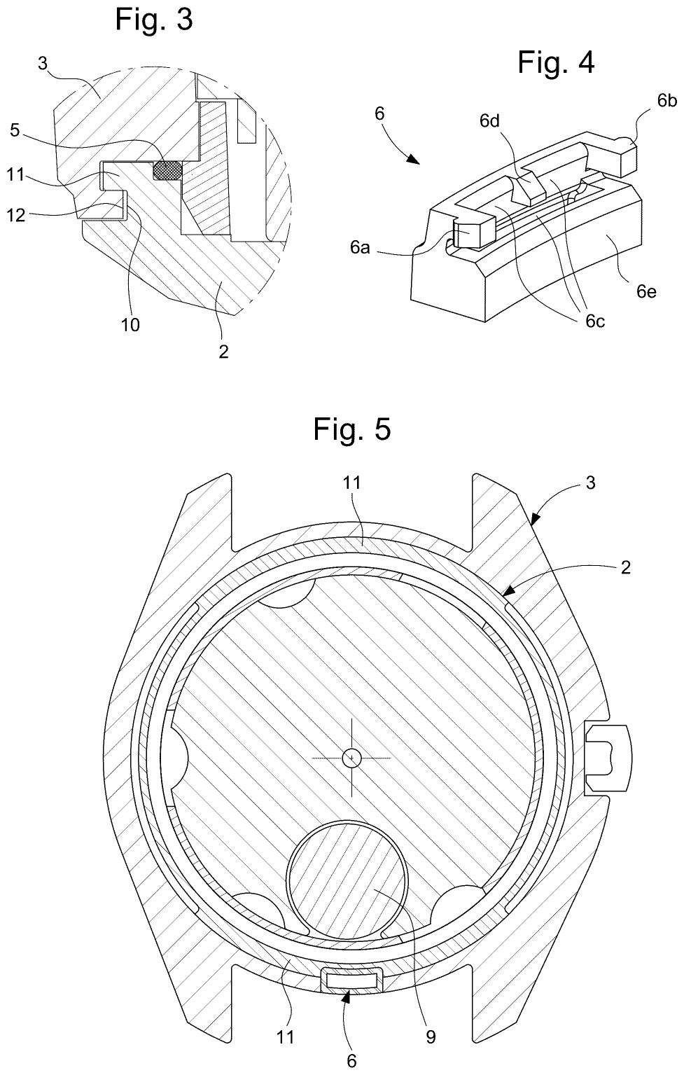

The invention relates to a watchcase 1 more specifically suitable for an electronic watch. Conventionally, it comprises a back 2, a middle 3 and a glass 4, as can be seen in FIGS. 1A and 2. The accessible face of the back 2 is provided with a slot 18 or orifices (not shown) for receiving a tool for detaching the back from the middle. The middle 3 and the glass 4 can be made in one piece with the glass soldered to the middle to form a container. The watchcase also comprises a water-resistant joint 5 between the middle 3 and the back 2, as shown in FIG. 3.

According to the invention, the back 2 and the middle 3 are assembled using a bayonet connector fitted with a bolt 6 to keep the back from rotating relative to the middle after assembly. This bolt 6 can be a part attached to the middle 3 and the back 2 as shown in FIGS. 1A and 5 to 6, or it can be an integral part of the back 2 as shown in FIG. 7. Preferentially, the bolt 6 is positioned between the horns 7 of the middle 3 so as to be concealed once the wristlet has been attached.

To ensure the bayonet connection, the back 2 comprises a groove 10 formed in a flange 11 extending in a circular arc around the periphery 2a of the back 2 towards the middle (FIGS. 1A and 1B). The groove 10 is open at least at one end of the circular arc to enable a flange 12 protruding into the middle 3 to engage, and optionally closed at the other end by a stop (not shown). FIG. 3 shows a cross-sectional view of this bayonet connection, with the flange 12 on the middle 3 engaged in the groove 10 in the back 2. Preferentially, there is a large number of flanges 11 and 12 around the perimeter 2a of the back 2 and inside the middle 3, respectively. In the example shown, there are 2 diametrically opposite flanges 11 and 12.

The middle 3 shown in FIG. 1A comprises a through bed 3a designed to hold a movement 8 and a cell 9 slotted in a compartment of the movement 8. The lateral wall of the bed 3a has the flanges 12 of the bayonet connector that extend radially from the lower end of the lateral wall, that is, from the end turned towards the back. A rim 15 is recessed in this lateral wall, with the joint 5 and the back 2 bearing on it.

To keep the back from rotating relative to the middle, a bolt 6 is fitted on the bayonet connector. In a first variant which can be seen in FIGS. 1A-1B-2 and 4-6, the bolt 6 is a part attached to the middle 2 and to the back 3. To this end, the groove 10 in the back 2 communicates with a notch 13 in the flange 11. The notch 13 is designed to be positioned facing an opening 14 made in the wall of the middle 3 to receive the bolt 6. Said opening 14 traverses the wall of the middle at the flange 12, optionally in the middle of the flange 12.

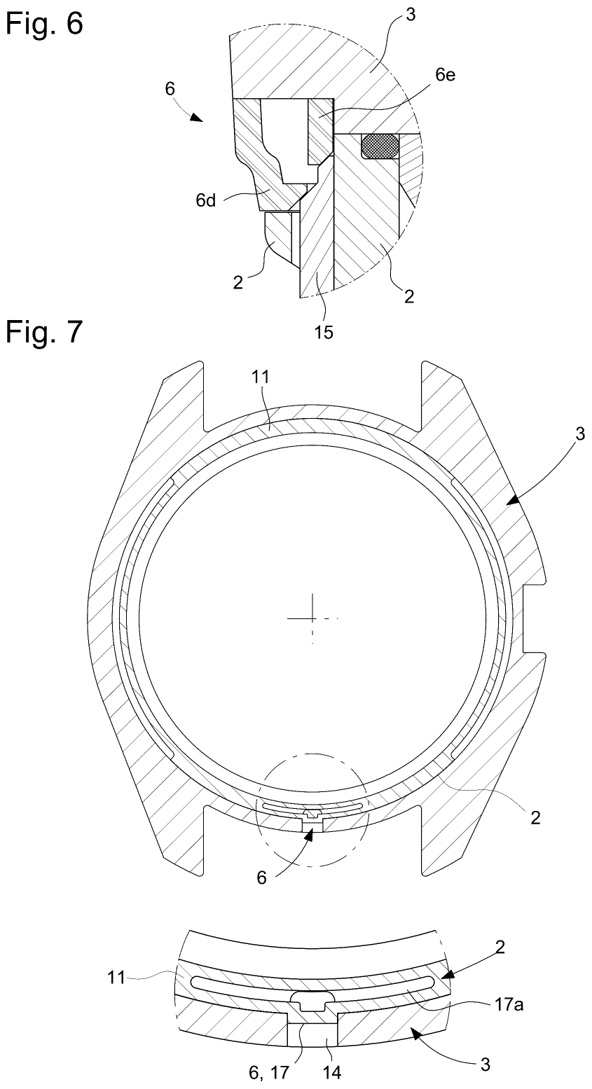

The bolt 6 according to the first variant is in the form of a flexible part with two hooks 6a, 6b at the lateral ends which hook onto the ends 11a, 11b of the flange 11 that frame the notch 13 in the back. As shown in FIG. 4, the bolt 6 has three recesses 6c in the example, to add this flexibility to the part. The bolt can also comprise a central tab 6d which separates two recesses 6c near the two hooks 6a, 6b. To keep the bayonet connector from rotating, the bolt is clamped to bring the two hooks 6a, 6b together and conjointly inserted into the opening 14 in the middle and into the notch 13 in the back. The two hooks 6a, 6b then return to their positions to hook onto the ends 11a, 11b of the flange. To remove the bolt, a tool 15 has to be inserted into a slot 16 in the back 2 (FIG. 1A). As shown in FIG. 6, the tool 15 presses on the tab 6d and on a wall 6e below the tab 6d, which retracts the hooks on the bolt and pushes it out of the middle.

According to a second variant, the bolt 6 is arranged directly in the back 2. Instead of the notch 13, the back 2 is provided with a flexible protruding portion 17 extending radially outwards from the back 2 at one of the flanges 11. The protruding portion 17 is made flexible by a recess 17a made in part of the flange 11 and optionally of the protruding portion 17. As a result, the back does not have a notch 13 to receive the bolt, while the middle has its opening 14 to receive the protruding portion 17. When it is assembled with the bayonet connector, the protruding portion is compressed against the lateral wall of the bed 3a of the middle before dropping into the opening 14 in the middle and resuming its shape. To remove the bolt, a tool (not shown) is inserted laterally into the opening 14 in the middle to compress the protruding portion 17 and rotationally release the back.

Once the bolt has been removed, the watchcase can be disassembled by inserting a tool into the slot 18 in the back 2 to rotate the back.

1. A watchcase (1) comprising:
a middle (3) suitable for holding a movement (8);
a cell (9) slotted in a compartment of the movement (8);
a back (2) assembled with a bayonet connector in the middle (3); and
a bolt (6) fitted on the bayonet connector to lock any relative rotation between the back (2) and the middle (3).

2. The watchcase (1) according to claim 1,
wherein the back (2) comprises on its periphery (2a) at least a first flange (11) traversed by a groove (10) and
wherein the middle (3) comprises at least a second flange (12) protruding inside said middle (3), said groove (10) being open at least at one end to enable the second flange (12) to engage when the back (2) is rotated, and optionally closed at the other end by a stop to stop the rotation, the engagement of the second flange (12) in the groove (10) forming the bayonet connection.

3. The watchcase (1) according to claim 2, wherein the bolt (6) is a flexible part attached to the middle (3) and to the back (2), an opening (14) being made through the second flange (12) and the groove (10) communicating with a notch (13) made in the first flange (11), said notch (13) being positioned facing the opening (14) to jointly receive the bolt (6).

4. The watchcase (1) according to claim 3, wherein the bolt (6) comprises two hooks (6a, 6a) for respectively hooking onto the ends (11a, 11b) of the first flange (11) that frame the notch (13) in the back (2).

5. The watchcase (1) according to claim 3, wherein the bolt (6) has recesses (6c) to add flexibility to said bolt (6).

6. The watchcase (1) according to claim 3, wherein the back (2) is traversed by a first slot (16) for receiving a first tool (15) in order to apply a force to said bolt (6) ensuring its removal from the watchcase (1).

7. The watchcase (1) according to claim 6, wherein the bolt (6) comprises a tab (6d) arranged between the hooks (6a, 6b) and a wall (6e) below said tab (6d) to which the force is applied.

8. The watchcase (1) according to claim 2,
wherein the bolt (6) forms an integral part of the back (2) and is in the form of a flexible portion (17) protruding radially outwards from the back (2), and
wherein an opening (14) is made through the second flange (12), said flexible portion (17) being compressed against the middle (3) during assembly with the bayonet connector before dropping into the opening (14) of the middle (3) and resuming its shape to ensure bolting, unbolting being ensured by a second tool introduced into the opening (14) of the middle (3) to compress the flexible portion (17).

9. The watchcase (1) according to claim 8, wherein the flexible portion (17) is made flexible by a recess (17a) made in one part of the first flange (11) and optionally in the flexible portion (17).

10. The watchcase (1) according to claim 1, wherein the bolt (6) is positioned between the horns (7) of the middle (3).

11. The watchcase (1) according to claim 1, wherein the back (2) comprises on its visible face a second slot (18) or orifices for positioning a third tool for mounting and removing the back (2), ensuring that it is rotated relative to the middle (3).
